(19) United States
(12) Patent Application Publication
(10) Pub. No.: US 2008/0041046 A1
(43) Pub. Date: Feb. 21, 2008

(54) Engine waste heat recovery system

(75) Inventor: Christopher Adam Bering, Dike, IA (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/504,998

(22) Filed: Aug. 16, 2006

(51) Int. Cl. F01N 5/02; F02B 29/04; F01D 15/10

(52) U.S. Cl. 60/320; 290/52; 60/599

(57) ABSTRACT

A waste heat recovery system is provide for a vehicle having a plurality of heat generating components and an engine cooling circuit. The system includes a heat collecting circuit collecting heat from the components and the engine cooling circuit, and a power generating circuit operating on a Kalina cycle. The heat collecting circuit operates with a first working fluid, and the power generating circuit operates with a second working fluid. The power generating circuit drives a turbine which drives an electric generator. A heat transfer unit transfers heat from the heat collecting circuit to the power generating circuit. The power generating circuit including an exhaust gas cooler for super-heating the second working fluid.

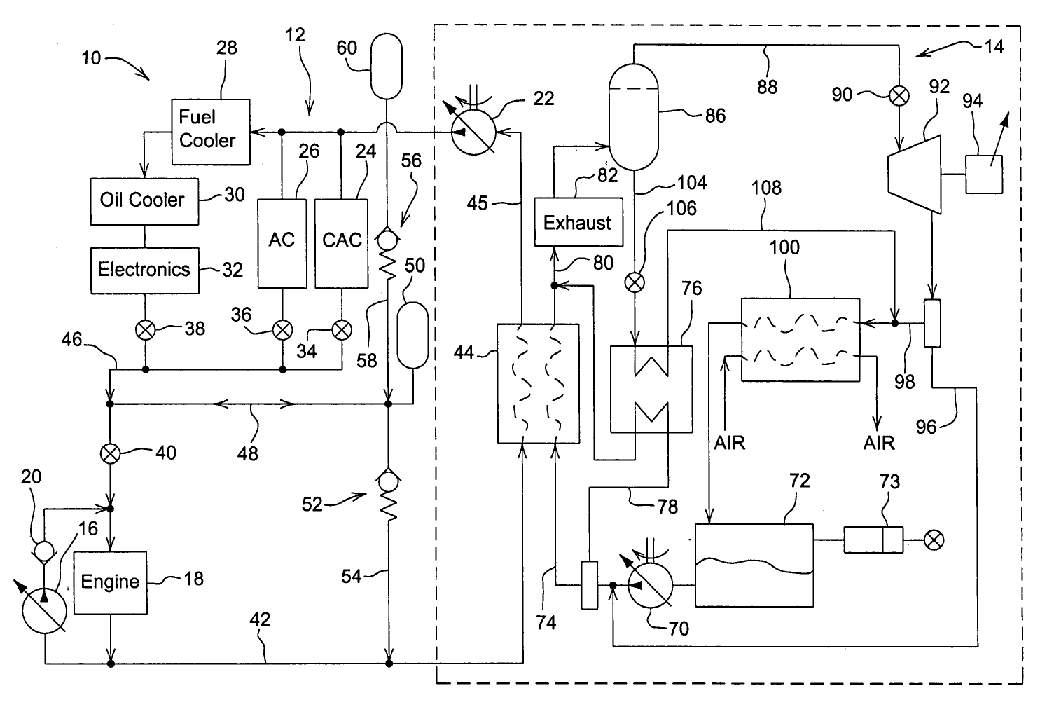

### BACKGROUND

The present invention relates to an engine waste heat recovery system.

Every internal combustion engine produces waste heat. At low speeds, this waste heat is difficult to dispose of and has traditionally required expending significant amounts of energy to do so. This problem is compounded on agricultural vehicles and construction vehicles in the absence of the “ram” air effect that on-highway type have. It is expected that stricter emissions regulations will cause engines to produce even more heat. Currently, space under vehicle hoods limits the size of the cooling system and its ability to meet the emissions regulations without increasing the energy required to reject the waste heat. The amount of energy wasted is proportional to engine efficiency and fuel economy. Increasing the amount of useful work that can be done with the energy produced during the combustion process is an ongoing challenge.

### SUMMARY

Accordingly, an object of this invention is to provide a system to capture the energy in the waste heat generated in a vehicle which might otherwise would be wasted.

This and other objects are achieved by the present invention, wherein a waste heat recovery system is provided for a vehicle having a plurality of heat generating components and an engine cooling circuit. The system includes a heat collecting circuit collecting heat from the components and the engine cooling circuit, and a power generating circuit operating on a Kalina cycle. The heat collecting circuit operates with a first working fluid, and the power generating circuit operates with a second working fluid. The power generating circuit drives a turbine which drives an electric generator. A heat transfer unit transfers heat from the heat collecting circuit to the power generating circuit. The power generating circuit including an exhaust gas cooler for super-heating the second working fluid.

### BRIEF DESCRIPTION OF THE DRAWINGS

The sole FIGURE is a schematic diagram of a vehicle waste heat recovery system embodying the invention.

### DETAILED DESCRIPTION

The vehicle waste heat recovery system 10 includes a heat collecting circuit 12 and a power generating circuit 14. Heat collecting circuit 12 includes an engine driven variable speed first pump 16 which circulates a first working fluid, such as glycol/water, primarily through the conventional engine cooling circuit 18. A check valve 20 assures one-way flow of the working fluid. A variable speed second pump 22 which circulates the first working fluid through a plurality of heat generating components, including a charge air cooler 24, an air conditioner condenser 26, a fuel cooler 28, an oil cooler 30 (such as a transmission oil cooler), and heat generating electronics components 32. Valve 34 allows the selective opening or closing of flow of working fluid through charge air cooler 24. Valve 36 allows the selective opening or closing of flow of working fluid through air conditioner condenser 26. Valve 38 allows the selective opening or closing of flow of working fluid through fuel cooler 28, oil cooler 30 and the electronics components 32. Valve 40 allows the selective opening or closing of communication between the engine 18 and the other heat generating components 24-32.

Line 42 communicates heated first working fluid to a heat transfer unit 44 which transfers heat from circuit 12 to circuit 14. Line 45 communicates first working fluid from heat transfer unit 44 to second pump 22. Line 46 communicates heated first working fluid from valves 34-38 to valve 40 and the engine 18. Line 48 provides two-way communication between an accumulator 50 and line 46. A pressure control valve 52 and line 54 permits one-way communication from line 48 to line 42. A pressure control valve 56 and line 58 permits one-way communication from accumulator 60 to line 48.

Power generating circuit 14 preferably circulates a second working fluid, such as ammonia/water, at a higher pressure than the glycol/water pressure in heat collection circuit 12. Circuit 14 includes a variable speed pump 70 which receives the second working fluid from a holding/de-aeration tank 72. An accumulator 73 is connected to tank 72 for the purpose of maintaining pressure in the system.

Pump 70 pumps the second working fluid to the heat transfer unit 44 via line 74 and to a recuperator unit 76 via line 78. Line 80 communicates heated second working fluid to an exhaust gas cooler 82 which operates to super-heat the second working fluid. Line 84 communicates super-heated second working fluid to a separator unit 86. Separator unit 86 operates to separate any liquid from the vapor prior to entering the turbine 92. Recuperator unit 76 transfers heat from the hot liquid leaving the separator unit 86 to the cooled liquid starting the next cycle.

Line 88 communicates super-heated second working fluid via valve 90 from separator unit 86 to a turbine 92. Turbine drives an electrical generator 94 which can supply useful electrical power to any desired electrical powered device (not shown) on or off the vehicle, such as on an implement (not shown) coupled to the vehicle or an electrical powered tool or machine (not shown).

Lines 96 communicates working fluid from turbine 92 to an outlet of pump 70. Line 98 communicates working fluid from line 96 to an air cooled condenser 100. Line 102 communicates condensed working fluid from condenser 100 to tank 72.

Line 104 and valve 106 communicate working fluid from separator 86 to recuperator 76. Line 108 communicates working fluid from recuperator 76 to condenser 100 via line 98.

As a result, heat from a plurality of heat generator components, which might otherwise be wasted, is used to generate useful electrical power. Circuit 14 converts the waste heat to electricity by using an additional power generation cycle based on a modified Rankine cycle, known as a Kalina Cycle. The super-heating by the engine exhaust ensures maximum temperature change in the ammonia/water solution, and hence, maximum work output from the system.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A waste heat recovery system for a vehicle having a plurality of heat generating components and an engine cooling circuit, the system comprising:
a heat collecting circuit collecting heat from the components and the engine cooling circuit, the heat collecting circuit having a first working fluid;
a power generating circuit operating on a Kalina cycle, the power generating circuit having a second working fluid;
a turbine driven by the power generating circuit;
an electric generator driven by the turbine; and
a heat transfer unit transferring heat from the heat collecting circuit to the power generating circuit.

2. The waste heat recovery system of claim 1, wherein:
the first working fluid comprises glycol/water; and
the second working fluid comprises ammonia/water.

3. The waste heat recovery system of claim 2, wherein:
the heat collecting circuit operates at a lower pressure and the power generating circuit operates at a higher pressure.

4. The waste heat recovery system of claim 1, wherein:
the heat collecting circuit collects heat from the engine cooling circuit and at least one of a group of heat generating components including a transmission oil cooler, a hydraulic oil cooler, a combustion air cooler, an air conditioning component, electronics components, and a fuel cooler.

5. The waste heat recovery system of claim 1, wherein:
the power generating circuit includes an exhaust gas cooler for transferring heat to the second working fluid.

6. The waste heat recovery system of claim 5, wherein:
the exhaust gas cooler is downstream of the heat transfer unit.

7. The waste heat recovery system of claim 1, wherein:
the heat collecting circuit includes a pair of pumps, one of the pumps pumping the first working fluid from the heat transfer unit to the heat generating components.

8. The waste heat recovery system of claim 1, wherein:
the heat collecting circuit includes an accumulator communicated with the engine cooling circuit.

9. The waste heat recovery system of claim 8, wherein:
the accumulator is communicated with the heat transfer unit through a pressure control valve.

10. A waste heat recovery system for a vehicle having a plurality of heat generating components and an engine cooling circuit, the system comprising:
a heat collecting circuit collecting heat from the components and the engine cooling circuit, the heat collecting circuit having a first working fluid;
a power generating circuit operating on a Kalina cycle, the power generating circuit having a second working fluid;
a turbine driven by the power generating circuit;
an electric generator driven by the turbine; and
a heat transfer unit transferring heat from the heat collecting circuit to the power generating circuit, the power generating circuit including an exhaust gas cooler for transferring heat to the second working fluid.

11. The waste heat recovery system of claim 10, wherein:
the exhaust gas cooler is downstream of the heat transfer unit with respect to flow of the second working fluid.
